(19) United States
(12) Patent Application Publication
(10) Pub. No.: US 2025/0134308 A1
(43) Pub. Date: May 1, 2025

(54) Portable and Convertible Cooking Device

(71) Applicant: Andrew Martin Liles, New Orleans, LA (US)

(72) Inventor: Andrew Martin Liles, New Orleans, LA (US)

(21) Appl. No.: 19/006,509

(22) Filed: Dec. 31, 2024

(51) Int. Cl. A47J 37/07; A23B 4/052; F24C 1/16; F24C 15/08

(52) U.S. Cl. CPC A47J 37/0731; A23B 4/0523; A23B 4/0526; A47J 37/0763; A47J 37/0786; F24C 1/16; F24C 15/086; A47J 2037/0777; A47J 2037/0795

(57) ABSTRACT

A portable and convertible cooking device comprises a grilling and smoking cabinet, a tether, and a leg assembly, where the cabinet is convertible from a grill to a smoker and back to a grill. The cabinet is moveable from a fixed horizontal position on the leg assembly, for operating the cooking device as a grill, to a fixed vertical position on the leg assembly, for operating the cooking device as a smoker where the tether holds the cabinet in the smoking position. As such, the portable and convertible outdoor cooking device converts from a grill to a smoker quickly and easily. The leg assembly comprises a pair of U-shaped stands which are pivotally connected at respective hinges, such that the leg assembly is collapsible. The portable and convertible cooking device has a pair of wheels for easy transport of the cooking device while in the collapsed position.

### BACKGROUND OF THE INVENTION

### Field of the Invention

The present invention generally relates to the field of outdoor cooking devices and, more particularly, to a portable and convertible grill assembly with a combination of a grill and a smoker configuration.

### Description of the Related Art

In general, barbeque grills are devices that cook food by applying heat from below. There are several varieties of grills, with most falling into one of two categories either gas-fueled or charcoal. Gas grills use propane or natural gas as their fuel source. Typically, gas grills are easier to use when compared to charcoal grills and can reach higher temperatures more quickly. However, gas grills can be more expensive to operate and may not produce the smoky flavor of charcoal grills. The charcoal grills use either charcoal briquettes or natural lump charcoal as their fuel source. When burned, the charcoal transforms into embers, thereby radiating the heat necessary to cook food. The charcoal grills typically take a longer time to heat up than gas grills, but they can produce a smoky flavor.

A smoker is used to cook food at low temperatures in a controlled, smoky environment. Smokers work by circulating a low and steady stream of heat through a smoking chamber. The stream of heat creates steam which slowly cooks the food for a tender and flavorful finish.

At present, a user has to buy a barbeque grill and a smoker device separately, which is expensive, and the two separate devices take up more space. The conventional barbeque grill assemblies are mounted on wheels to facilitate their movement from one location to another, often in outdoor areas of the home. Further, the existing barbecue grill assemblies comprise a bowl-like base set on a suitable support such as a central pedestal or legs with wheels to make the unit portable.

While conventional barbeque grills may be suitable for the particular purposes employed, they would not be as suitable for the purposes of the present invention as disclosed hereafter. None of such conventional barbeque grills disclose the unique features and advantages of the present disclosure. The cooking device disclosed herein avoids many of the drawbacks of existing devices.

Accordingly, there is a need for a portable convertible outdoor cooking device that can be used as a grill as well as a smoker when converted.

It is one prospect of the present invention to provide a portable outdoor cooking device that can be converted from a grill to a smoker quickly and easily. It is another object of the invention to provide a combination portable grill and smoker device of simple and efficient construction.

Another object of the present invention is to provide a portable grill which easily converts to a smoker device that is easy to transport from one location to another.

As disclosed in this application, the inventor has discovered novel and unique cooking devices for efficiently and effectively converting a grill into a smoker, while requiring less space and at less expense than conventional devices.

### SUMMARY OF THE INVENTION

The following presents a simplified summary of the present disclosure in a simplified form as a prelude to the more detailed description that is presented herein.

Therefore, in accordance with embodiments of the invention, there is provided a portable and convertible cooking device, convertible from a food grill to a food smoker. In a preferred embodiment, the portable and convertible cooking device comprises a cabinet comprising a door pivotally connected to the cabinet, wherein the cabinet is adapted to enclose food items to be cooked. The cabinet has a first end opposite a second end.

In a preferred embodiment, the portable and convertible cooking device comprises a leg assembly having a first end opposite a second end. The first end of the cabinet is pivotally connected to the first end of a leg assembly. In a preferred embodiment, the cabinet is moveable from a fixed horizontal position on said leg assembly, such that the portable and convertible cooking device is adapted to operate as a food grill, to a fixed vertical position on said leg assembly, such that said portable and convertible cooking device is adapted to operate as a food smoker.

In another preferred embodiment, the portable and convertible cooking device comprises a tether unit that connects a second end of the leg assembly opposite the first end of the leg assembly, where tether unit is removably connected to the second end of the cabinet. The tether unit is adapted to support the cabinet in the vertical position on the leg assembly. In one embodiment, the tether unit is a chain unit. In yet another embodiment, the tether unit is a cable.

In a preferred embodiment, the tether unit comprises at least two cables. The at least two cables are tether cables. In a preferred embodiment, a first cable of the two cables is connected to respective bend portions of the pair of U-shaped stands such that the first cable is adapted to provide restrain against collapse of the leg assembly. In a preferred embodiment, a second cable of the two cables comprises a first end connected to a bend portion of one U-shaped stand and comprises an opposite end detachably attached to a hook unit fixed to a bottom surface of the cabinet.

In one embodiment, the cabinet comprises a plurality of air intake orifices that are disposed on the sides of the cabinet to control the smoking process when the portable and convertible cooking device is operated as the smoker in the smoking position as well as to control the air flow when the portable and convertible cooking device is operated as a grill in the grilling position.

In a preferred embodiment, the cabinet comprises at least two sets of internal brackets that are fixed inside the cabinet. Each set of internal brackets is preferably positioned on opposing internal edges of the cabinet. Each set of internal brackets is configured to hold at least one grill grate while the cabinet is fixed in the horizontal position on the leg assembly for operating the cooking device as the grill.

In another preferred embodiment, when the cabinet is fixed in the vertical position on the leg assembly for operating the cooking device as the smoker, a first set of internal brackets of the two sets of internal brackets are configured to hold a first grill for holding the food items, and a second set of internal brackets of the two sets of internal brackets are configured to hold a second grill to hold a water tray for smoking the food items. In another embodiment, the second set of internal brackets of the two sets of internal brackets are configured to hold the second grill for smoking food items placed atop the second grill at a position closer to the heat and thus at a higher temperature.

In another preferred embodiment, the cabinet comprises a pair of internal hooks that are configured to retain a basket for wood chips and charcoal for smoking the food items.

In one embodiment, the leg assembly comprises a pair of U-shaped stands. In such embodiment, each U-shaped stand comprises two parallel legs, where ends of at least one U-shaped stand are attached with wheels. In another embodiment, ends of both U-shaped stands are attached to wheels, such that there are four wheels at the bottom of the parallel legs of the U-shaped stands.

In one embodiment, the portable and convertible cooking device comprises a tether unit, preferably in the form of at least one cable or wire. In such embodiment, the tether unit preferably includes flexible cables with eyelets or hooks on its respective ends, in place of the chain unit.

In a preferred embodiment, the chain unit comprises at least two chains. The chains are tether chains. A first chain of the at least two chains is removably connected to respective bend portions of the pair of U-shaped stands such that the first chain is adapted to provide restrain against collapse of the leg assembly. A second chain of the two chains is connected to a bend portion of one U-shaped stand and the other end is detachably attached to a bottom surface of the cabinet, where it is preferably connected to a hook unit disposed thereon.

In another preferred embodiment, the cabinet comprises a pair of food item holders forming on a top portion of the cabinet when the cabinet is converted into the vertical position. In one embodiment, the pair of food item holders is configured to hold a rod to suspend the food items in the vertical position.

### BRIEF DESCRIPTION OF THE DRAWINGS

Illustrative embodiments of the present invention are described herein with reference to the accompanying drawings, in which:

FIG. 1A depicts a perspective front view of a portable and convertible cooking device, in accordance with embodiments of the invention;

FIG. 1B depicts a perspective side view of the portable and convertible cooking device, in accordance with embodiments of the invention;

FIG. 1C depicts a perspective view of the portable and convertible cooking device as a smoker, in accordance with embodiments of the invention;

FIG. 2 depicts a perspective view of a chain unit of the portable and convertible cooking device, in accordance with embodiments of the invention;

FIG. 3A depicts a perspective view of an opened portable and convertible cooking device as the smoker, in accordance with embodiments of the invention;

FIG. 3B depicts a perspective view of the opened portable and convertible cooking device as the smoker with at least one grill and a basket, in accordance with embodiments of the invention;

FIG. 3C depicts a perspective view of the opened portable and convertible cooking device as the smoker with at least one food item for smoking, in accordance with embodiments of the invention;

FIG. 3D depicts a perspective view of the opened portable and convertible cooking device as the smoker with two grills, the basket, and a water tray, in accordance with embodiments of the invention;

FIG. 4 depicts a perspective view of the opened portable and convertible cooking device as a grill, in accordance with embodiments of the invention; and

FIG. 5 depicts a perspective view of the portable and convertible cooking device in a collapsed position, adapted for transport by an exemplary user.

### DETAILED DESCRIPTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

Reference will now be made in detail to the present preferred embodiments of the invention, examples of which are illustrated in the accompanying drawings. Wherever possible, the same reference numerals are used in the drawings and the description to refer to the same or like parts.

The present disclosure has been made with a view towards solving the problem with the prior art described above, and it is an object of the present invention to provide a portable and convertible grill assembly with a combination of a grill and a smoker configuration.

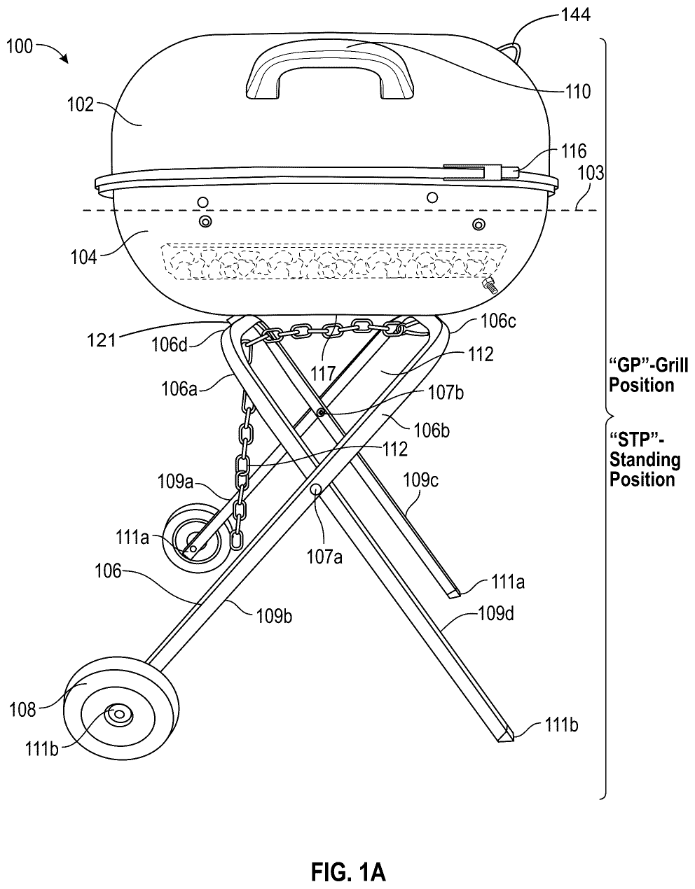

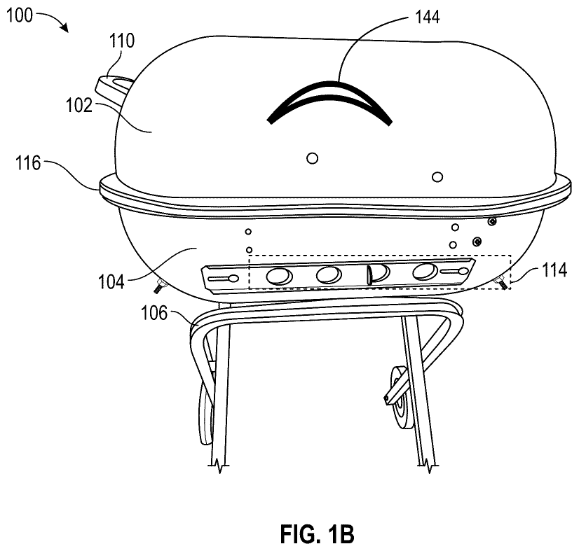

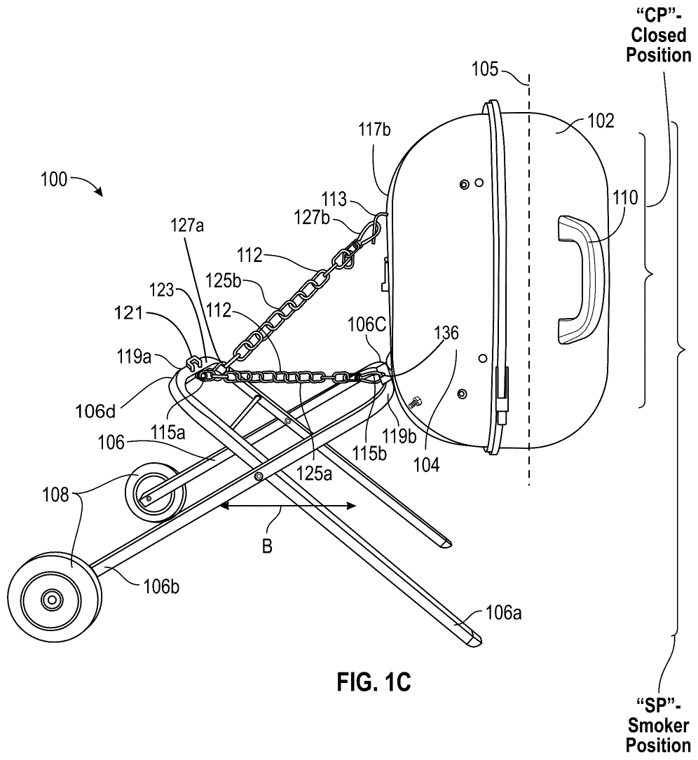

Referring initially to FIGS. 1A-1C, the basic constructional details and principles of operation of embodiments of a portable and convertible cooking device 100 are provided.

As illustrated, FIG. 1A depicts a perspective front view of the portable and convertible cooking device 100 in a Grill Position “GP”, where it is adapted for use by a user as a food grill. FIG. 1B depicts a perspective side view of the portable and convertible cooking device 100 in the grill position “GP”. FIG. 1C depicts a perspective view of the portable and convertible cooking device as a smoker, meaning, in a Smoker Position “SP”, where it is adapted for use by a user as a food smoker.

The portable and convertible cooking device 100 comprises a cabinet 104 that is fixed with a door 102 access. The door 102 includes a handle 110, and the door 102 is pivotally attached to the cabinet 104 with linkages, and the door 102 is configured to pivot or swing vertically indicated with Arrow “A” from a Closed Position “CP” to an Open Position “OP”, and back to the closed position “CP”. In such closed position “CP”, the door 102 can enclose food items inside the cabinet 104 for operating the portable and convertible cooking device 100 as a grill, as shown in FIG. 1A. Referring to FIG. 1A, the cabinet 104 is fixed in a horizontal position 103 on a leg assembly 106 for operating the cooking device 100 as a grill. Alternately, when converted, the cabinet 104 is fixed in a vertical position 105 on the leg assembly 106 for operating the cooking device 100 as the smoker, as shown in FIG. 1C, as detailed further below.

Preferably, the cabinet 104 comprises a plurality of air intake orifices 114 that are disposed on sides of the cabinet 104 to control the smoking process when the cooking device 100 is operated as the smoker, as shown in FIG. 1B, when the portable and convertible cooking device 100 is in the smoker position “SP”. Such plurality of air intake orifices 114 also control the grilling process when the cooking device 100 is operated as a grill, when the portable and convertible cooking device 100 is in the grill position “GP”.

Further, a securing means 116, such as a latch 116, is attached to the door 102 for firmly closing and opening the door 102.

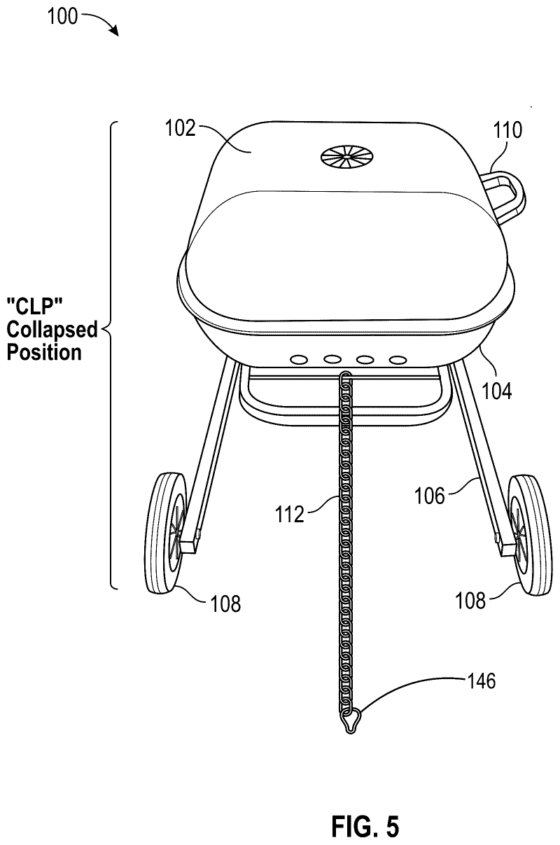

In a preferred embodiment, the leg assembly 106 comprises a pair of U-shaped stands 106a, 106b, which are pivotally connected to each other at respective hinges 107a, 107b. The leg assembly 106 is moveable from a Standing Position “STP” as shown in FIG. 1A, to a Collapsed Position “CLP”, as shown in FIG. 5. While in the Collapsed Position “CLP”, a user can lift upwardly on the handle 144 (FIG. 1A) to tilt the cabinet 104 and U-Shaped stands 106 upward relative to the wheels 108, such that the user can roll the and transport the portable and convertible cooking device 100, as desired.

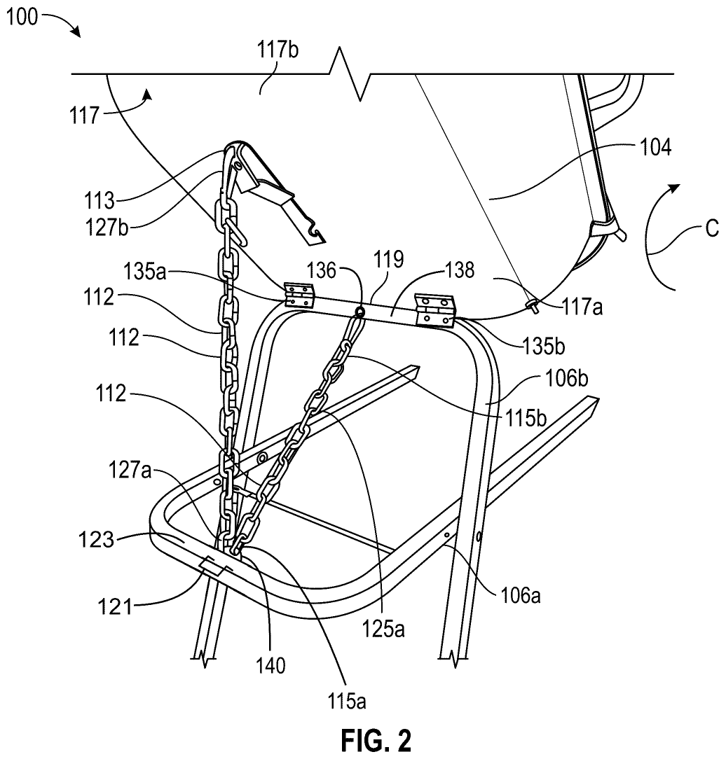

In one embodiment, the cabinet 104 is movably (rotatably or pivotally) connected to one of the U-shaped stands 106a, 106b using links 135a and 135b. In a preferred embodiment, the cabinet 104 is movably connected to the U-shaped stand 106b with links in the form of hinges 135a and 135b, as shown in FIG. 2.

In a preferred embodiment, referring to FIG. 1A, each U-shaped stand 106a, 106b respectively comprises two parallel legs 109a,109b,109c,109d, where bottom ends 111a,111b of at least one U-shaped stand 106b are attached to respective wheels 108. In another embodiment, bottom ends of both U-shaped stands 106a,106b are attached to four respective wheels 108. The wheels 108 are configured to enable a user to easily transport the cooking device 100 from one location to another, while in a collapsed position “CLP”, as illustrated in FIG. 5, providing better portability than conventional devices.

In a preferred embodiment, the cooking device 100 comprises a tether unit 112 that is connected to the cabinet 104 and to the leg assembly 106. In one embodiment, the tether unit 112 is a steel cable. In another embodiment, as is illustrated in FIG. 1C and FIG. 2, the tether unit 112 is a chain unit 112, which includes a first chain 125a and second chain 125b.

The first chain 125a of the chain unit 112 has a first end 115a that is removably attached to a first end 106d of the leg assembly 106. The first chain 125a of the chain unit 112 has an opposite second end 115b that is fixed to the second end 106c of the leg assembly 106. The chain unit 112 is configured to enable a proper fixed extension of the leg assembly 106, where the chain unit 112 provides restraint against a collapse (in the direction of Arrow B) of the leg assembly 106. The chain unit 112 provides support to the cabinet 104 on the leg assembly 106 while the cabinet 104 is in the horizontal position 103, and the chain unit 112 also provides support while the cabinet 104 is in the vertical position 105, as shown in FIG. 1A and FIG. 1C.

In a preferred embodiment, the tether unit 112 comprises at least two cables. The cables are tether cables, preferably made of steel. In a preferred embodiment, a first cable of the two cables is connected to respective bend portions of the pair of U-shaped stands such that the first cable is adapted to provide restrain against collapse of the leg assembly, in the same manner as described herein relative to the tether chain 125a. In a preferred embodiment, a second cable of the two cables comprises a first end connected to a bend portion of one U-shaped stand and comprises an opposite end detachably attached to a hook unit fixed to a bottom surface of the cabinet, in the same manner as described herein relative to the tether chain 125b.

In yet another embodiment, as illustrated in FIG. 1A, the cabinet 104 has a bottom surface 117 having a first portion 117a hingedly (FIG. 2 at 135a and 135b) connected to an upper portion 119 of one U-shaped stand 106. As shown in FIG. 2, the first portion 117 of the cabinet 104 preferably include two hinges 135a, 135b which hingedly connect the cabinet 104 to the upper portion 119b of the U-shaped stand 106b of the leg assembly 106. In such manner, the cabinet 104 can pivot relative to the to the upper portion 119b of the U-shaped stand 106b.

Referring to FIGS. 1C and 2, the bottom surface 117 of the cabinet 104 includes an opposing portion 117b which includes a hook 113 affixed to the bottom surface 117 thereof, where such hook 113 is adapted to removably connect to a bended eyelet 121 that is fixed to and disposed on a bend 123 of the opposing U-shaped stand 106a, as illustrated in FIGS. 1-2. In such embodiment, the bottom surface 117 of the cabinet 104 serves as the tether between the opposing pair of U-shaped stands 106a, 106b, when the portable and convertible cooking device 100 is in the grill position “GP”, which is the Standing Position “STP”, as illustrated in FIG. 1A, where the bottom surface 117 of the cabinet 104 provides restraint against a collapse (in the direction of Arrow B) of the leg assembly 106. In other words, the bottom surface 117 of the cabinet 104 provides restraint against movement in the direction of Arrow B.

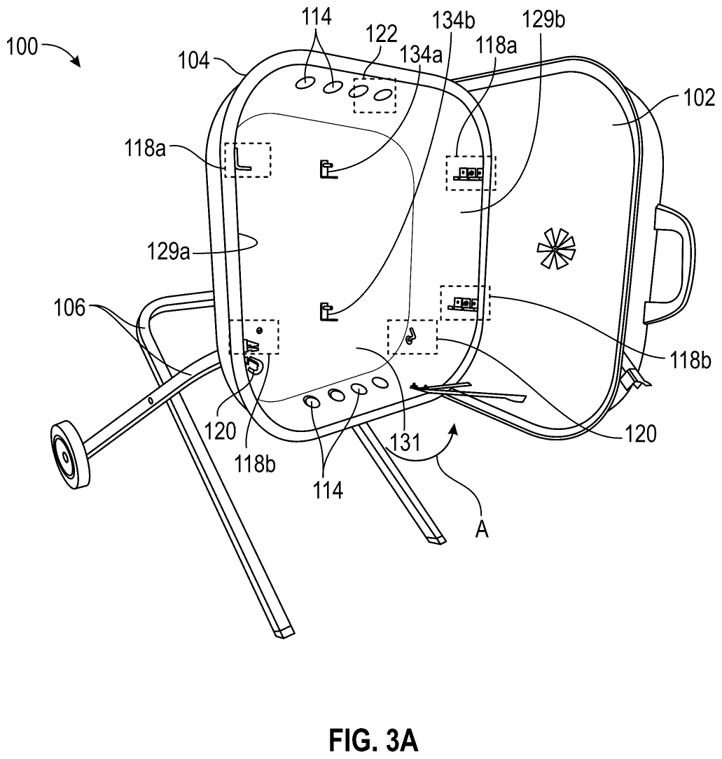

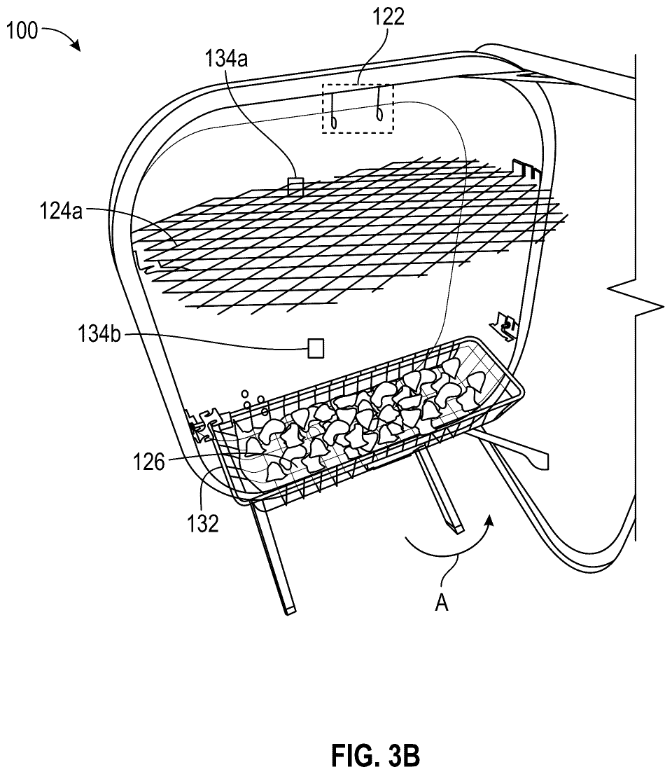

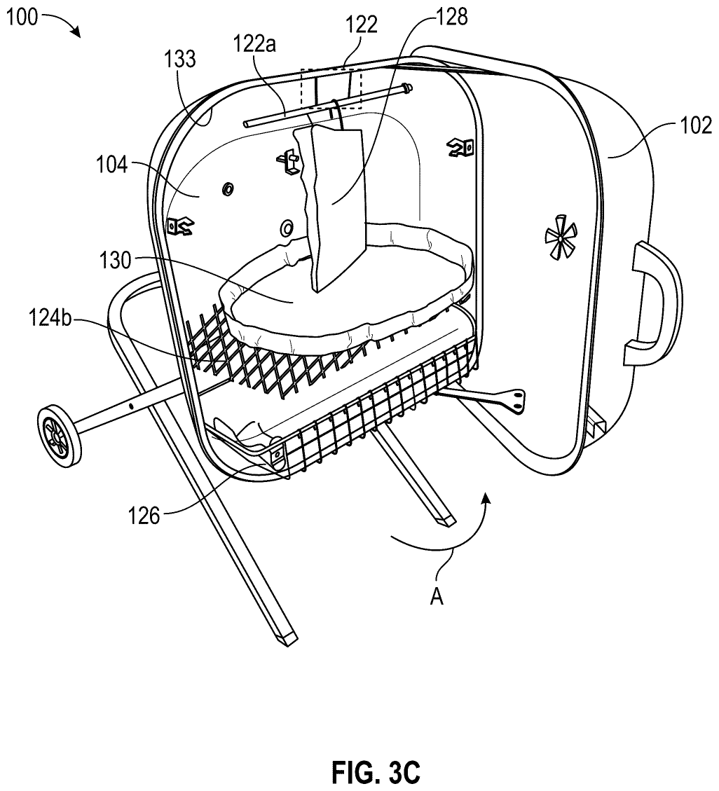

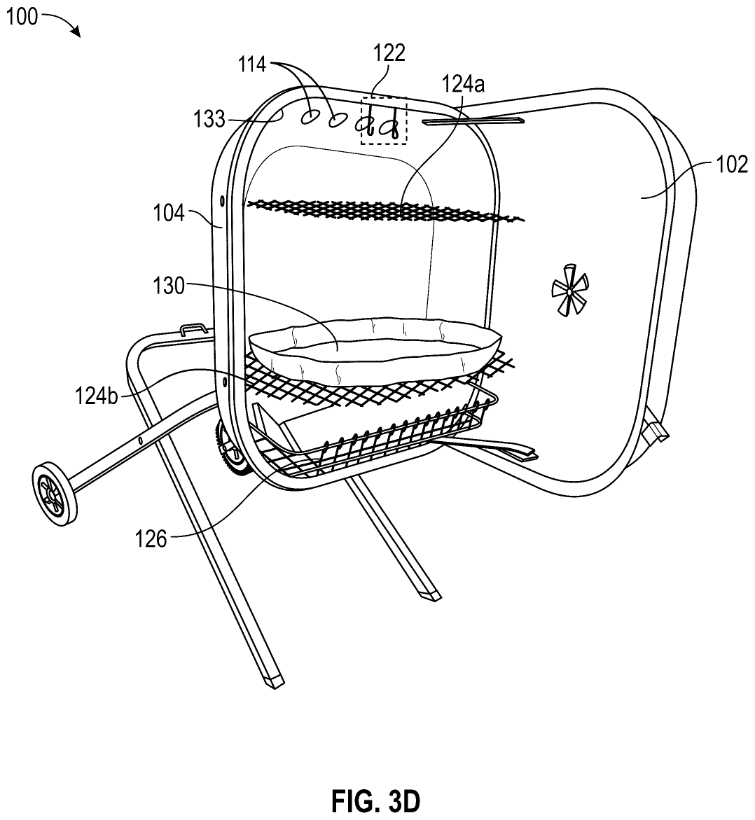

As illustrated in FIG. 1C, the chain unit 112 serves as a tether connecting respective upper portions 119a, 119b of the two U-shaped stands 106a, 106b of the leg assembly 106, as the cabinet 104 is positioned in the vertical position 105 on the leg assembly 106, which enables the cooking device 100 to operate as the smoker, as shown in FIG. 1C. In such embodiment, the door 102 is configured to pivot or swing horizontally (in the direction of Arrow A in FIG. 3A) from a closed position “CP” (FIG. 1C) to an open position “OP” (FIG. 3A), and back to the closed position “CP” (FIG. 1C). In such closed position “CP” (FIG. 1C), the door 102 can enclose food items inside the cabinet 104 for operating as a smoker.

In a preferred embodiment, the chain unit 112 comprises a single tether chain or a pair of tether chains.

As illustrated in FIG. 2, the connection of the chain unit 112 with the cabinet 104 and the leg assembly 106 is depicted, as the cabinet 104 is being rotated (in the direction of Arrow C) into the smoker position “SP”.

In one embodiment, the chain unit 112 preferably comprises at least two chains 125a, 125b. The two chains 125a, 125b are tether chains.

Referring to FIG. 2, the first chain 125a of the chain unit 112 has one end 115a that is connected to a tether eyelet 140 that is fixed to a bend portion 123 of the U-shaped stand 106a of the pair of U-shaped stands 106a, 106b. The first chain 125a of the chain unit 112 has an opposing, second end 115b that is connected to an aperture 136 that is defined by a bend portion 138 of the U-shaped stand 106b of the pair of U-shaped stands 106a, 106b. The first chain 125a of the chain unit 112 limits the extension of the stand 106 so as to enable a proper extension of the leg assembly 106, as illustrated in FIG. 1A, FIG. 1C and FIG. 2, when in the Smoker Position (FIG. 1C), where it can be operated a food smoker.

Further, a second chain 125b of the chain unit 112 has a first end 127a fixed to the tether eyelet 140 that is fixed to the bend portion 123 of the U-shaped stand 106a. The second chain 125b has a second end 127b (opposite the first end 127a) that is fixed to a hook aperture 142 that is defined by the hook 113, as illustrated in FIG. 2.

In a preferred embodiment, the second end 127b of the second chain 125b is detachably (or removably) attached to the bottom surface 117 of the cabinet 104 through the hook aperture 142 of the hook unit 113, as illustrated in FIG. 2.

In another embodiment, the bottom surface 117 of the cabinet 104 defines a slot through which the second end 127b of the chain unit 125b can removably be inserted into the slot for attachment. In such embodiment, the second end 127b of the chain unit 125b is preferably in the form of a hook adapted for insertion into such slot, which is defined by bottom surface 117 of the cabinet 104.

Referring to FIG. 2, in a preferred embodiment, the hook unit 113 is fixed to the bottom surface 117 of the cabinet 104. The second chain 125b connects the hook unit 113 and respective bottom 117b of the cabinet to the U-shaped stand 106a, and as such, the second chain 125b supports the cabinet 104 when the cooking device 100 is converted to the vertical position 105, as illustrated in FIGS. 1C-2 and FIGS. 3A-3D, where the cooking device 100 can be operated as a food smoker in the Smoker Position.

In one embodiment, a user can lift up the bottom surface 117 of the cabinet 104 from the leg assembly 106 and attach the other end 127b of the second chain 125b to the hook unit 113 (preferably using a carabiner 146), such that the cabinet 104 can be converted into the vertical position 105, therefore enabling the portable and convertible cooking device 100 to be used as a smoker. As illustrated in FIGS. 1-3A, the cabinet 104 is rotatable from the horizontal position 103 to the vertical position 105, while using the chain unit 112 to limit the extension between the U-shaped stands 106a, 106b of the leg assembly 106 and to provide restraint of the cabinet 104 against tipping over, allowing the portable and convertible cooking device 100 to be used as the smoker. In other words, the chain unit 112 provides restraint for the cabinet 104 against shear forces when the portable and convertible cooking device 100 is in the vertical position 105, thereby holding the cabinet 104 in the vertical position 105 (i.e., upright position), where it can be operated a food smoker, in the Smoker Position.

Referring to FIG. 3A, a perspective view is provided of the portable and convertible cooking device 100 as positioned in the vertical position 105, as a smoker device, with its door 102 in an open position “OP”. The cabinet 104 preferably comprises at least two sets of internal brackets (118a and 118b) that are fixed inside the cabinet 104. Each internal bracket (118a and 118b) is preferably positioned on each edge 129a, 129b (i.e., opposing internal edges) of the cabinet 104, as shown in FIG. 3A.

In a preferred embodiment, referring to FIGS. 3A and 3B, when the cabinet 104 is fixed in the vertical position 105 on the leg assembly 106 for operating the portable and convertible cooking device 100 as the food smoker, a first set of internal brackets 118a of the at least two sets of internal brackets 118a, 118b is configured to hold a first grill grate 124a which is adapted to hold the food items 128 while smoking those foods items. The first set of internal brackets 118a are preferably disposed on internal upper side of each edge 129a, 129b of the cabinet 104, as shown in FIGS. 3A-3B.

In one embodiment, the cabinet 104 comprises a pair of internal hooks 120. The internal hooks 120 are preferably fixed to respective lower internal portion 131 of the cabinet 104. The internal hooks 120 are configured to retain a basket 126 for wood chips and charcoal 132 for smoking the food items 128 placed on the first grill grate 124a.

In one embodiment, the cabinet 104 comprises a pair of supporting hooks 134a and 134b. The supporting hooks 134a and 134b are preferably fixed inside the cabinet 104 to support the first grill grate 124a and the basket 126.

In one embodiment, the cabinet 104 comprises a pair of food item holders 122 such as food hooks. The food item holders 122 are fixed to top portion 133 of the cabinet 104, as illustrated in FIG. 3D, when the cabinet 104 is in the vertical position 105, which is the smoker position “SP”.

Referring to FIG. 3C, when the cabinet 104 is positioned in the vertical position 105 on the leg assembly 106 for operating the portable and convertible cooking device 100 as the smoker, the food item holders 122 are configured to preferably hold a rod 122a to suspend the food item 128 inside the cabinet 104 while the cabinet 104 is in the vertical position 105.

Further, a second set of internal brackets 118b of the at least two sets 118a, 118b of internal brackets are configured to hold a second grill grate 124b to hold a water tray 130 for smoking the food item 128. The second set of internal brackets 118b are preferably formed on internal lower side of each edge 129a, 129b of the cabinet 104. A user then puts burning wood and charcoal 132 in the basket 126, and the smoking of the food item 128 is started. The user may close the door 102 while the food items 128 are being smoked. During the smoking process, the air intake orifices 114 that are disposed on sides of the cabinet 104 enable air to flow into the cabinet 104 to control and enhance the smoking process.

Referring to FIG. 3D, when the cabinet 104 is fixed in the vertical position 105 on the leg assembly 106 for operating the portable and convertible cooking device 100 as the smoker, the door 102 can pivot horizontally (in the direction of Arrow A) to open the door 102, preferably with assistance of the handle 110. Next, the first grill grate 124a is inserted in the cabinet 104. The first set of internal brackets 118a hold the first grill grate 124a for holding the food items 128. Next, the user places at least one or more food items 128 on the first grill grate 124a. In a preferred embodiment, the first grill grate 124a is configured to hold multiple food items 128 for smoking them. Next, the second grill grate 124b is inserted in the cabinet 104, and the water tray 130, which is filled with water is placed on the second grill grate 124b. Preferably, the second set of internal brackets 118b hold the second grill grate 124b with the water tray 130 for smoking the food items 128. Next, the basket 126 can be inserted by the user into the cabinet 104, while the portable and convertible cooking device 100 is in the Smoking Position. The basket 126 is attached to the internal hooks 120, and the user can place burning wood chips and charcoal 132 in the basket 126 for smoking the food items 128.

After putting the burning wood chips and charcoal 132 in the basket 126, the user can close the door 102, which tightly closes the cabinet 104 through the securing means 116.

The door 102 can be opened after a certain time period to check the food items 128 for proper smoking of the food items 128. Further, the food items 128 can be rotated on the first grill grate 124a to provide proper smoking of the food items 128. The second set of internal brackets 118b hold the second grill grate 124b to hold the water tray 130 for smoking the food item 128.

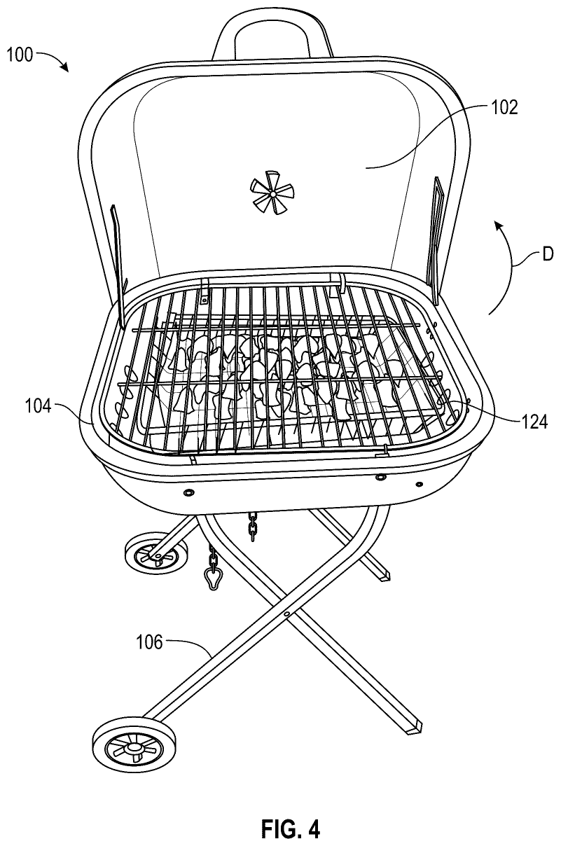

FIG. 4 depicts a perspective view of the portable and convertible cooking device 100 in a horizontal position 103, as a grill. The cabinet 104 is fixed in the horizontal position 103 on the leg assembly 106 for the portable and convertible cooking device 100 as the grill. Each internal bracket (118a and 118b) is configured to hold at least one grill grate 124 when the cabinet 104 is fixed in the horizontal position 103 on the leg assembly 106 for operating the portable and convertible cooking device 100 as the grill. The grill grate 124 is configured to hold multiple food items 128 for grilling.

Referring to FIG. 4, when the cabinet 104 is fixed in the horizontal position 103 on the leg assembly 106 for operating the portable and convertible cooking device 100 as the grill, the door 102 can pivot vertically (in the direction of Arrow D) to open the door 102, preferably with assistance of the handle 110.

In one embodiment, the user can place wood burning chips and charcoal 132 inside at the bottom of the cabinet 104. Next, one or more food items 128 are placed on the grill grate 124, and grilling of the food items 128 is performed by burning wood chips and charcoal 132. Further, the food items 128 can be rotated on the grill grate 124 to provide proper grilling of the food items 128.

FIG. 5 illustrates the portable and convertible cooking device 100 in a collapsed position “CLP”, where the leg assembly 106 lays nearly flat on the ground, adapted for transport by a user. The portable and convertible cooking device 100 can be collapsed by folding the leg assembly 106 to the ground level where the cabinet 104 is supported onto the folded leg assembly 106. As can be seen in FIG. 5, the portable and convertible cooking device 100 can be collapsed, and the user can easily lift and pull upwardly on the handle 144 (FIG. 1A) of the portable and convertible cooking device 100 to rotate the cabinet 104 upward off of the ground, leaving its wheels 108 on the ground, and then transport the portable and convertible cooking device 100 by rolling it on its wheels 108.

As can appreciated from the illustration in FIG. 5, the collapsible nature of the portable and convertible cooking device 100 allows a user to easily and conveniently store the portable and convertible cooking device 100 when not in use.

As can be appreciated from the disclosure herein, embodiments of the invention provide for a portable device that can be used for not only food grilling activities but also food smoking activities, in a safe and efficient manner.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation within the spirit and scope of the appended claims.

The claimed invention is:

1. A portable and convertible cooking device, comprising:
a cabinet comprising a door pivotally connected to the cabinet, said cabinet adapted to enclose food items to be cooked, said cabinet having a first end opposite a second end, the first end of the cabinet pivotally connected to a first end of a leg assembly, wherein said cabinet is moveable from a fixed horizontal position on said leg assembly such that said portable and convertible cooking device is adapted to operate as a food grill, to a fixed vertical position on said leg assembly such that said portable and convertible cooking device is adapted to operate as a food smoker;
a chain unit connected to a second end of the leg assembly opposite the first end of the leg assembly, said chain unit removably connected to the second end of the cabinet, wherein said chain unit is adapted to support the cabinet in the vertical position on the leg assembly.

2. The portable and convertible cooking device of claim 1, wherein the cabinet comprises a plurality of air intake orifices that are disposed on sides of the cabinet, said plurality of air intake orifices adapted to control smoking operations.

3. The portable and convertible cooking device of claim 1, wherein the cabinet comprises at least two sets of internal brackets that are fixed inside the cabinet, wherein each set of internal brackets is positioned on a opposing internal edges of the cabinet, wherein each set of internal brackets is configured to hold at least one grill grate while the cabinet is fixed in the horizontal position on the leg assembly.

4. The portable and convertible cooking device of claim 3, wherein when the cabinet is fixed in the vertical position on the leg assembly for operating the cooking device as the smoker, a first set of internal brackets of the at least two sets of internal brackets are configured to hold a first grill to hold the food items, wherein a second set of internal brackets of the at least two sets of internal brackets are configured to hold a second grill to hold a water tray for smoking the food items.

5. The portable and convertible cooking device of claim 1, wherein the cabinet comprises a pair of internal hooks that are configured to retain a basket for wood chips and charcoal for smoking the food items.

6. The portable and convertible cooking device of claim 1, wherein the leg assembly comprises a pair of U-shaped stands pivotally connected to each other.

7. The portable and convertible cooking device of claim 6, wherein each U-shaped stand comprises two parallel legs, wherein respective ends of at least one U-shaped stand are attached to respective wheels.

8. The portable and convertible cooking device of claim 1, wherein the chain unit comprises at least two chains, wherein the at least two chains are tether chains.

9. The portable and convertible cooking device of claim 8, wherein a first chain of the at least two chains is connected to respective bend portions of the pair of U-shaped stands such that the first chain is adapted to provide restrain against collapse of the leg assembly.

10. The portable and convertible cooking device of claim 8, wherein a second chain of the at least two chain units is connected to a bend portion of one U-shaped stand and other end is detachably attached to a hook unit fixed to a bottom surface of the cabinet.

11. The portable and convertible cooking device of claim 1, wherein the cabinet comprises a pair of food item holders forming on a top portion of the cabinet when the cabinet is converted into the vertical position, wherein the pair of food item holders is configured to hold a rod to suspend the food items in the vertical position.

12. A portable and convertible cooking device, comprising:
a cabinet comprising a door pivotally connected to the cabinet, said cabinet adapted to enclose food items to be cooked, said cabinet having a first end opposite a second end, the first end of the cabinet pivotally connected to a first end of a leg assembly, wherein said cabinet is moveable from a fixed horizontal position on said leg assembly such that said portable and convertible cooking device is adapted to operate as a food grill, to a fixed vertical position on said leg assembly such that said portable and convertible cooking device is adapted to operate as a food smoker;
a tether unit connected to a second end of the leg assembly opposite the first end of the leg assembly, said tether unit removably connected to the second end of the cabinet, wherein said tether unit is adapted to support the cabinet in the vertical position on the leg assembly.

13. The portable and convertible cooking device of claim 12, wherein the cabinet comprises a plurality of air intake orifices that are disposed on sides of the cabinet, said plurality of air intake orifices adapted to control smoking operations.

14. The portable and convertible cooking device of claim 12, wherein the cabinet comprises at least two sets of internal brackets that are fixed inside the cabinet, wherein each set of internal brackets is positioned on a opposing internal edges of the cabinet, wherein each set of internal brackets is configured to hold at least one grill grate while the cabinet is fixed in the horizontal position on the leg assembly.

15. The portable and convertible cooking device of claim 14, wherein when the cabinet is fixed in the vertical position on the leg assembly for operating the cooking device as the smoker, a first set of internal brackets of the at least two sets of internal brackets are configured to hold a first grill to hold the food items, wherein a second set of internal brackets of the at least two sets of internal brackets are configured to hold a second grill to hold a water tray for smoking the food items.

16. The portable and convertible cooking device of claim 12, wherein the cabinet comprises a pair of internal hooks that are configured to retain a basket for wood chips and charcoal for smoking the food items.

17. The portable and convertible cooking device of claim 12, wherein the leg assembly comprises a pair of U-shaped stands pivotally connected to each other.

18. The portable and convertible cooking device of claim 17, wherein each U-shaped stand comprises two parallel legs, wherein respective ends of at least one U-shaped stand are attached to respective wheels.

19. The portable and convertible cooking device of claim 1, wherein the tether unit comprises at least two cables, wherein the at least two cables are tether cables.

20. The portable and convertible cooking device of claim 19, wherein a first cable of the at least two cables is connected to respective bend portions of the pair of U-shaped stands such that the first cable is adapted to provide restrain against collapse of the leg assembly.

21. The portable and convertible cooking device of claim 19, wherein a second cable of the at least two cables comprises a first end connected to a bend portion of one U-shaped stand and comprises an opposite end detachably attached to a hook unit fixed to a bottom surface of the cabinet.

22. The portable and convertible cooking device of claim 12, wherein the cabinet comprises a pair of food item holders forming on a top portion of the cabinet when the cabinet is converted into the vertical position, wherein the pair of food item holders is configured to hold a rod to suspend the food items in the vertical position.
